(19) United States
(12) Patent Application Publication
(10) Pub. No.: US 2008/0010229 A1
(43) Pub. Date: Jan. 10, 2008

(54) INTELLIGENT AGENT BASED DEVELOPMENT PLATFORM

(76) Inventor: RAYMOND LEE SHU TAK, Kowloon (HK)

Correspondence Address: Irving M. Weiner;Weiner & Burt, P.C., 635 N. US-23, P.O. Box 186, Harrisville, MI, 48740, US

(21) Appl. No.: 11/693,313

(22) Filed: Mar. 29, 2007

(30) Foreign Application Priority Data
Jul. 5, 2006 (CN) 200610061542.5

(51) Int. Cl. G06F 15/18

(52) U.S. Cl. 706/14; 706/21

(57) ABSTRACT

The present invention relates to an intelligent agent technology (IAT) based development platform. Said platform provides intelligent agent based development platform. The development platform comprises: a first module provides full artificial intelligence and intelligent agent technology (IATology) based application interface for constructing various intelligent agent application; a second module for data storage and analyzing data intelligently as well as provided the analyzed results to said first module. The present invention provides an intelligent agent system with real sense analysis and logical illation capability. In addition, an intelligent ontological agent-based development environment (IATo) is provided to be the basic frame and development platform of the future intelligent E-business.

### FIELD OF THE INVENTION

The present invention relates to artificial intelligent and information technology, particularly, relates to an intelligent ontological agent model as the basic framework and development environment for e-commerce applications.

### BACKGROUND OF THE INVENTION

In information technology, especially intelligence and computer science field, intelligent agent is considered to a device which can recognize the environment by its sensors, and respond to the environment with its executive device. For example, referring to human body, eyes, ears and other sensory organs are the cognitive devices, while the executive devices are hands, legs, mouths and other parts of the body. When it comes to software, the cognitive and executive organs are encoded character streams.

The main purpose of artificial intelligence is to design intelligent agent programs, that is, to implement the mapping methods of cognition and action. This intelligent agent program has to operate on a certain computing device called framework. Said framework may be a common computer, or a special hardware tailored to perform certain tasks, or certain software between a computer and intelligent agent program for providing a certain degree of isolation, which enables programming in higher layers. In general, the structure enables the information as received by the sensors to transform as cognition, and provide feedback via execution program and hence produce a response.

Owing to the rapid development of e-Commerce and Internet technology in the recent years, many different e-Commerce applications and mobile computing systems have been operated in this cyberspace.

E-business is viewed as a big business opportunity as more and more people are focusing on the Internet. Numerous products are now available on the Internet, and product searching has become a burden for buyers. Meanwhile, sellers are difficult to locate target buyers and provide targeted promotion. It will be convenient to implement intelligent agent system, such that the agent system may actively search for online advertisements for buyers, go shopping online and even bargain for a better price, while the agent system simultaneously works for the seller to analyze different consumers' trends, and promote certain products to potential customers.

Therefore, in this ‘sea’ of information pool, the provision of an intelligent-based system (such as intelligent agents) seems to be a ‘New Hope’ in the future. However, contemporary agent-based developing environment such as IBM Aglet and ObjectSpace Voyager the provision of ‘real’ intelligent agent functionality is failed to support.

### BRIEF SUMMARY OF THE INVENTION

We propose an innovative intelligent ontological agent-based development environment namely IATopia—“Intelligent Agent Utopia”. The aim of IATopia is to provide comprehensive AI and ontological agent-based APIs and applications for future e-commerce and ontological-based applications.

The framework composes of two main model. The first module is “Application-Ontology-Intelligent-Technology-Supporting Layer” (AOITS) and the second module is “Data-Neural Network-Application Layer” (DNA)

The first module is a full artificial intelligence and ontology agent based application interface which constructs various intelligent agent application; and

The second module is used for data storage, intelligent data analysis process, and providing analyzed results to said first module.

The said first module comprises:

Application layer, comprises various intelligent ontology agent based application programs, said application programs are integrated by intelligent agent components of the intelligent layer and the data of said second module.

Ontology layer, base on the brain knowledge of agent, provides necessary knowledge for agent to initiate its logical and knowledgeable thinking. This layer of brain knowledge is named IATology-20000.

Intelligent layer, provides artificial intelligence basic base on the sense field, logical illation field and analysis field, while utilizes agent components provided by technology layer.

Technology layer, provides necessary mobile agent object application program interface for intelligent agent components of intelligent layer, comprises providing IATo SDK software development tools of full multi-intelligent agent based development platform, and providing understandable marking language to increase the communication of intelligent agent and IATo ML development tools of data transferring; and

Supporting layer, provides all necessary systems for supporting said layer, comprises programming languages, communication protocols and standardized file exchange format that are adopted to facilitate the development of the IATopia framework.

The said second module comprises:

Data layer, for storing raw data from intelligent agent brain. It is also the source of knowledge.

Neural network layer, for manipulating the data stored in the data layer so that knowledge can be generated and the thinking process can be initiated as well as the agent can learn or correct itself according to its experiences; and

Application layer, with the fully support from the data layer and neural network layer, agent have enough knowledge and thinking capability to live and work autonomously.

The application programs in the said application layer comprise:

IATo eMiner, an intelligent ontological web-mining agent system for e-shopping.

IATo InfoSeeker, an intelligent ontological knowledge based information searching system.

IATo WeatherMAN, an intelligent ontological weather forecasting agent.

IATo WShopper, an integrated ontological intelligent fuzzy shopping agent for intelligent mobile shopping on the Internet.

IATo Stock Advisor, an intelligent ontological agent based stock prediction system.

IATo Surveillant, the automatic ontological agent based surveillance system.

The said intelligent agent comprises the following requirements: autonomous, mobile, reactive, proactive, adaptive, robust, communicative, learning, task-oriented, goal-driven.

The said IATo SDK development tools comprise all the mandatory components arranged on intelligent agent development platform. Said mandatory components comprise intelligent agent managing system, information transferring server and index arbitrator.

The basic function and run time properties of the said intelligent agent are defined by intelligent agent, lifecycle manager that provides all the control function, registration manager that records intelligent agent registration information in the intelligent agent development platform, and communication manager that controls the message transfer in intelligent agent platform.

The said application program interface comprises: the first region that provides the functions of creating, activating, invalidating, copying, distributing, releasing and exiting, the second region that provides the functions of writing logs and displaying the information of activation in the server, the third region that provides tree type intelligent agent list, and the forth region that provides information broadcasting type.

The present invention provides an intelligent agent system with real sense, analysis and logical illation capability. In addition, an intelligent agent utopia (IATo) based development platform is provided to be the basic frame and development platform of the future intelligent E-business.

### BRIEF DESCRIPTION OF THE DRAWINGS

FIG. 1 is the block diagram of the present invention.

FIG. 2 is the block diagram of the user interface, in accordance with the present invention.

FIG. 3 is the basic structure diagram of IATo SDK Intelligent Agent platform, in accordance with the present invention.

FIG. 4 is the schematic diagram of Intelligent Agent communication, in accordance with the present invention.

FIG. 5 is the schematic diagram of registration Intelligent Agent, in accordance with the present invention.

FIG. 6 is the schematic diagram of creation Intelligent Agent, in accordance with the present invention.

FIG. 7 is the schematic diagram of dispatch Intelligent Agent (sending end), in accordance with the present invention.

FIG. 8 is the schematic diagram of dispatch Intelligent Agent (receiving end), in accordance with the present invention.

FIG. 9 is the schematic diagram of the user interface, in accordance with the present invention.

FIG. 10 is the schematic diagram of creation Intelligent Agent dialog box, in accordance with the present invention.

FIG. 11 is the schematic diagram of dispatch Intelligent Agent dialog box, in accordance with the present invention.

### DETAILED DESCRIPTION OF THE INVENTION

The present invention disclosed a new intelligent ontology agent based development platform, called The Utopia of Intelligent Agent (IATopia) based development platform. The object is to develop a fully integrated intelligent ontology based multi-Intelligent Agent system, so as to be the basic frame and development platform of the future intelligent E-business.

The present invention may implement various Intelligent Agent based applications, comprising IATo TravelGuider and IATo Stock Advisor, etc.

In order to clarify the object, technical scheme and advantages of the present invention, various embodiments are described to provide detailed description of the present invention.

The framework of the present invention (functions and modules):

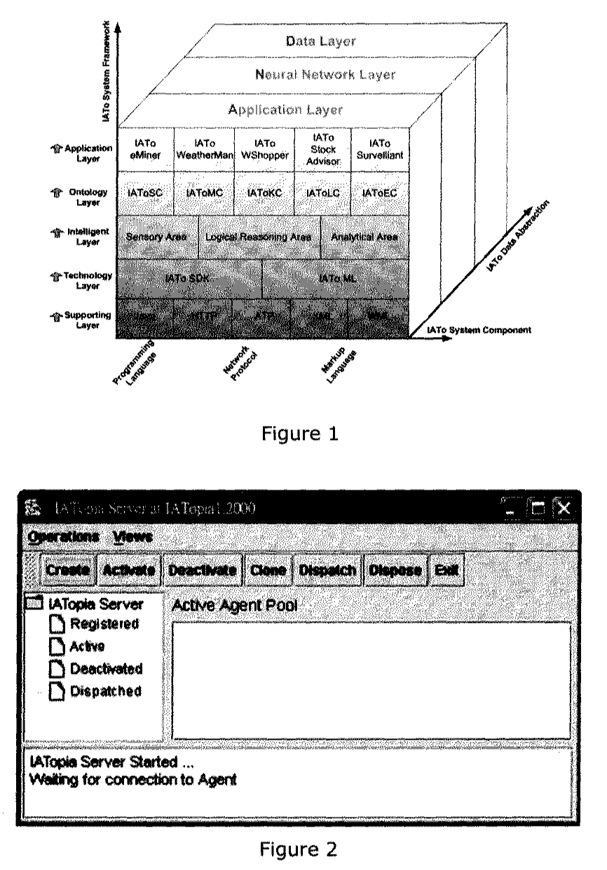

The present invention has fully integrated intelligent agent E-business application based intelligent ontology agent module. The system framework is shown in FIG. 1, unlike the Intelligent Agent system and Application Programming Interfaces (APIs) in the prior art, such as, IBM Aglets, ObjectSpace Voyager and IATo products. The present invention focuses on multi-Intelligent Agent communication and automatic operation. The object is to provide full artificial intelligence and ontology agent based APIs, as well as future E-business application and ontology agent based application.

As shown in FIG. 1, the framework of the present invention comprises two main modules: The first module is Application-Ontology-Intelligent-Technology-Supporting layer (AOITS) module, the second module is Data-Neural-Network-Application Layer (DNA) module. AOITS module comprises application layer, ontology layer, intelligent layer, technology layer and supporting layer. DNA module comprises data layer, neural network layer and application layer. Various layers of AOITS are described in detail as follows.

Application layer: On the top layer of the system, comprises different intelligent ontology agent based application programs. Said application programs (IATo) are integrated by the intelligent ontology agent components from intelligent layer and data knowledge fields from DNA module. Various exemplary application programs are realized in this layer, which comprises:

IATo eMiner, an intelligent ontological web-mining agent system for e-shopping, comprises 1) IATo Authenicator—an automatic authentication system based on human face recognition, and 2) IATo Shopper—a fuzzy agent based Internet shopping agent.

IATo InfoSeeker, an intelligent ontological knowledge based information searching system.

IATo WeatherMAN, an intelligent ontological weather forecasting agent, which is the extension of previous research on mult-station weather forecasting using fuzzy neural networks. Unlike traditional Web-mining agents, which focus on the automatic extraction and provision of the latest weather information. IATo WeatherMAN possesses neural network based weather forecasting capability (AI services provided by the ‘Conscious Layer’ of the IATopia module) to act as a ‘virtual’ weather reporter as well as an ‘intelligent’ weather forecaster for weather prediction.

IATo Shopper series, an integrated ontological intelligent fuzzy shopping agent with WAP technology for intelligent mobile shopping on the Internet.

IATo Stock Advisor, an intelligent ontological agent based stock prediction system using HRBFN (Hybrid Radial Basis Function Recurrent Network) for time series prediction.

IATo Surveillant, the automatic ontological agent based surveillance system.

Ontology Layer: based on the brain ontology knowledge of intelligent agent, provides necessary knowledge for intelligent agent to initiate its reasonable and knowledgeable thinking process. Said layer provides said ontology frame, that is the ontology centre, comprises the following 5 modules: Intelligent ontology based sensation centre (IAToSC), intelligent ontology based memory centre (IAToMC), intelligent ontology based knowledge centre (IAToKC), intelligent ontology based language centre (IAToLC), intelligent ontology based ethics centre (IAToEC).

Said five functional modules measure up the FIPA ontology service specification (XC00086D), an ontology agent (IATo Agent) will be designed and constructed with the following functions (namely, the “RATE” requirements):

Representation: to represent and discover public ontologies (especially ontologies in foreign platforms)

Administration: to maintain and administer the services and facilities provided by the iJAOS.

Translation: to communicate and translate concepts, meanings, and universals between different ontologies and/or different content languages.

Explanation: To respond to and explain all queries concerning relationships between different concepts and ontologies.

Intelligent layer: This layer provides the intelligent basis of the IATopia system, using the agent components provided by the ‘Technology layer’. The ‘Conscious Layer’ consists of the following three main intelligent functional areas:

Sensory area, for the recognition and interpretation of incoming stimulates, comprises: visual sensory agents using EGDLM (Elastic Graph Dynamic Link Model) for invariant visual object recognition, and, auditory sensory agents based on wavelet based feature extraction and interpretation technique.

Logic reasoning area, conscious and reasoning support, such as fuzzy and GA (genetic Algorithms) rule based systems.

Analytical area, comprises various AI tools for analytical calculation, such as recurrent neural network based analysis for real-time prediction and data mining.

The technology layer: This layer provides all the necessary mobile agent implementation APIs for the development of intelligent agent components in the ‘Conscious Layer’.

In the proposed latest version (v2.0) of the IATopia module, instead of IBM Aglets as the agent ‘backbone’, two innovative IATopia development tools have been developed, namely:

IATo SDK (IATopia Development Kit) and

IATo ML (IATopia Markup Language)

The main function of IATo SDK is to provide a comprehensive intelligent multi-agent based development platform with the provision for all the intelligent agent-based Java classes and library, comprises: agents' communications, negotiations, intelligent agent tools, etc. The main function of IATo ML is the provision of a comprehensive markup language to enhance the intelligent agent communication and data exchange.

In this layer, server-side computing using Java Servlet technology is also adopted due to the fact that for certain intelligent agent-based applications, such as the IATo Shopper Series, in which limited resources (in terms of memory and computational speed) are provided by the WAP devices (e.g. WAP phones), all the IATo agents interactions are invoked at the ‘backend’ WAP server using Java Servlet technology.

The supporting layer: This layer provides all the necessary system supports to the ‘Technology Layer’, comprises:
1. Programming language support based on Java,
2. Network protocols support such as HTTP, HTTPS, ATP, etc., and
3. Markup languages support such as HTML, XML, WML, etc.

Each layer of DNA module is described in detail as follows.

Data layer: This layer is for storing initial data from agent brain and for IATology-20000 to generate knowledge, at this point, the thinking process may be initiated, and agent may learn or correct itself according to its experiences. This layer also explains why agent may think as a human.

Application layer: With fully support from data layer and neural network layer, the agent has enough knowledge and thinking capabilities to live and work on its own.

Further description of intelligent agent technology (IAT) is provided as follows:

Presently, most of the E-business systems on the Internet employ client/server manner. The disadvantages are: 1) High communication burden; 2) reciprocity between enhanced and low level users. Certain objects are need to achieve said functions: Play the role of a human, to operate independently in the Internet, being autonomous, and to identify, process and solve problems on its own.

The definition of intelligent agent is: Intelligent agent (IA) is an example of intelligent in terms of device. IA may be a system, software program, program object or even a robot.

The intelligent agent in the present invention is with the following 10 basic requirements: 1) autonomous; 2) mobile; 3) reactive; 4) proactive; 5) adaptive; 6) robust; 7) communicative and cooperative; 8) learning; 9) task-oriented; 10) goal-driven. According to these basic requirements, the working theory of the IATopia agent in the present invention is described as follows:

IATopia Agent is a Java-based program. It is a sub-class of Thread class, so it can execute its life cycle asynchronously and concurrently inside the IATopia server. It implements the Serializable interface for packaging agent itself to migrate from host to host, and it also implements the Cloneable interface for copying itself to work concurrently with other instances of the agent. IATopia Server uses Java RMI as the transporting layer of IATopia Agents between IATopia hosts; agent will be serialized and sent to the target host by using RMI remote call.

IATo SDK framework in the implementation of IATopia:

IATo SDK is an intelligent agent development platform which implements FIPA Agent Management Specification utilizing Java 2 as the development language. The goal of IATo SDK is to provide an agent platform together with a set of API for simplify the development of agent system while ensuring the system is compliance to FIPA standard. The following table shows the basic building blocks of the platform.

Application Agents or Non-agent based user

application layer

| | |
|---|---|
| Agent Management | Directory Facilitators |
| Service | |

Agent Transport and communication System
Java 2 Standard Edition (JDK 1.4)

To achieve this goal, IATo SDK offers the following features:
1. A FIPA-compliant Agent Platform with Agent Management System, Directory Facilitators and Message Transporting System. All these components are automatically started with the agent platform.
2. A registration manager to act as a directory facilitator to act as yellow page for registering or searching an agent inside the platform.
3. Message transporting mechanism for agents to communicate with each other and dispatching agents.
4. A lifecycle manager as an agent management system to control the agent's lifecycle within an agent platform.
5. A graphical user interface for the users to manage, monitor and log an agent's activities (FIG. 2)

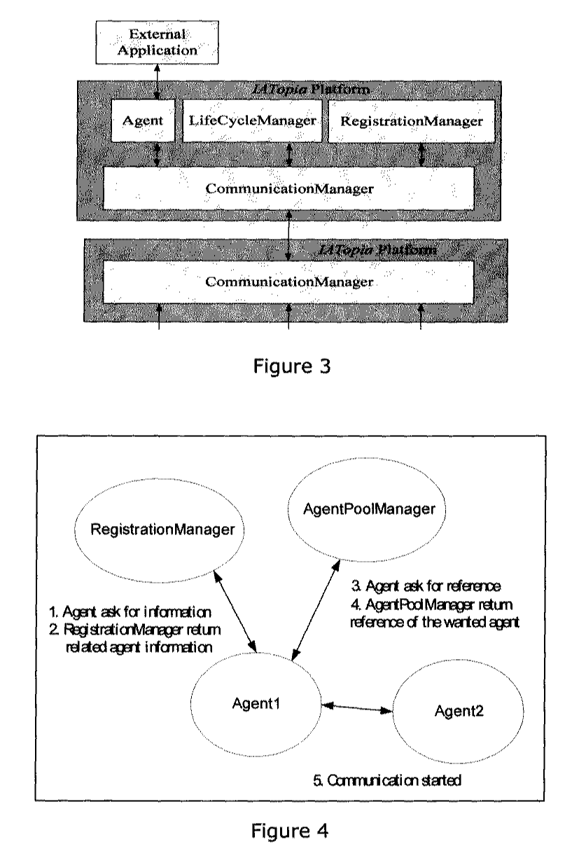

Basic component of IATo SDK: The IATo SDK agent platform is developed compliant with FIPA Agent Management Specification and includes all mandatory components that must be the in starting lineup with the agent platform, that are Agent Management System, Message Transport Service and Directory Facilitator. IATo SDK agent platform is developed by using pure Java 2 Standard Edition (JDK1.4). The mandatory components to startup IATo SDK agent platform are LifeCycleManager, RegistrationManager and CommunicationManager. FIG. 3 shows the basic architecture of the IATo SDK agent platform. IATo SDK provides the necessary mobile agent implementation APIs for the development of mobile intelligent agent systems. The basic functionalities and runtime properties of agents are defined by the Agent, LifeCycleManager RegistrationManager and CommunicationManager classes.

IIATo SDK provides necessary mobile intelligent agent object APIs for the development of mobile intelligent agent system. The basic function and run time property of intelligent agent are defined by Intelligent AgentPool, LifeCycleManager RegistrationManager and CommunicationManager.

Intelligent AgentPool: Basically, all agents must execute within a virtual place called AgentPool within the server. Thus, when an agent is created or dispatched, it must be put inside the AgentPool to start execution.

LifeCycleManager: LifeCyleManager act as the Agent Management System within the agent platform. It provides all functions of controls within the agent platform, comprises creating, suspending, resuming, dispatching and disposing agents.

Intelligent Agent: The Agent is the main character of the mobile agent concept. This is because it is a mobile software object that can transfer its softare code and status from one host to another in order to perform a specific task. This can convince the development of a Code on Demand system. The agent has its own mechanism to broadcast or send messages to another agent for communication. When agent wants to ask for a specific service from another agent, firstly it will ask the RegistrationManager for the related agent's information and then ask the AgentPoolManager to get the reference of the wanted agent for further communication using the message passing mechanism (FIG. 4).

RegistrationManager: The RegistrationManager maintains a list of the registered agent's information including the agent's name, classes location and information about the service that the agent provides. It also protects the IATopia Server from anonymous attack. This is because an agent must be registered before it is allowed to execute inside the agent platform.

CommunicationManager: The message channel is maintained by the CommunicationManager. It controls the messages passing within the agent platform. It also provides a network communication channel for the agent to dispatch from local to remote sites.

Internal operation of IATo SDK (Data flow and input/output): By using these basic components, IATopia Server can provide a number of operations that helps mobile agent to perform their task.

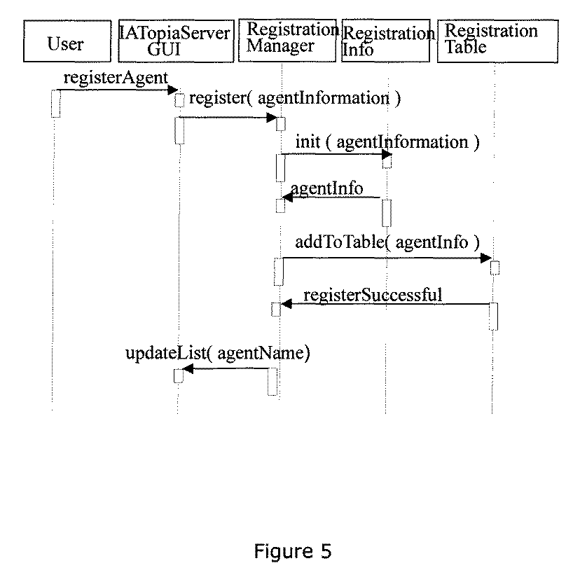

Register Intelligent Agent: as shown in FIG. 5, Agents must be registered before they can live in the IATopia Server. Therefore, users are required to input the agent's information (e.g. Agent's name, code base and task description) by using the graphic user interface provided by IATopia Server (IATopia Server GUI). After receiving agent's information from user input, IATopia Server GUI will generate a request to the RegistrationManager. RegistrationManager then initialize an object RegistrationInfo and then save in the RegistrationTable. Finally IATopia Server GUI will be updated to inform the user after the registration is successful.

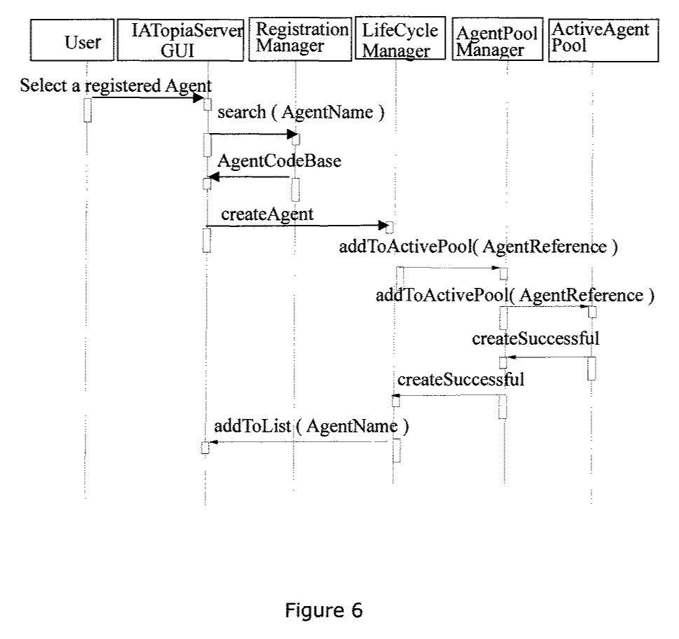

Create Intelligent Agent: as shown in FIG. 6, after registering an agent, user can create an agent by using the IATopia Server GUI, by choosing an appropriate agent's name in the list. The IATopia Server GUI will ask the RegistrationManager to get the basic code of the agent class file.

Then, IATopia Server GUI will send a request to the LifeCycleManager to create an agent. After the agent file is loaded into Java VM, the LifeCycleManger will send the agent's reference to the AgentPoolManager, the AgentPoolManger will add the agent reference to the ActiveAgentPool. Finally IATopia Server GUI will be updated to inform the user after the creation is successful.

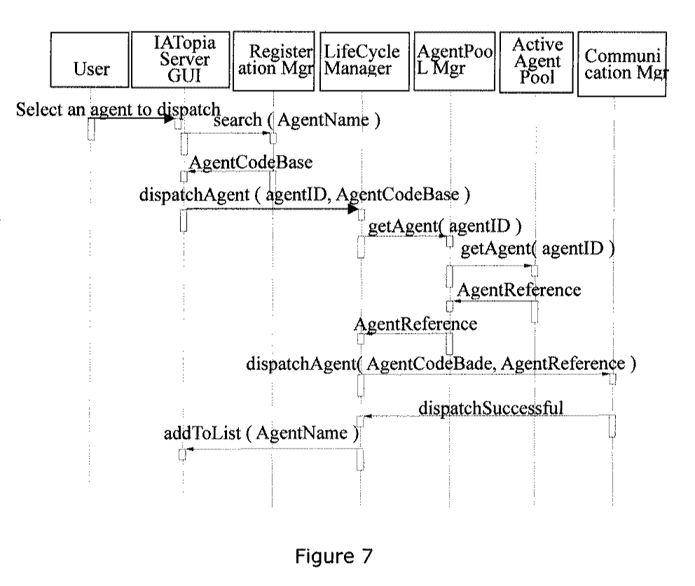

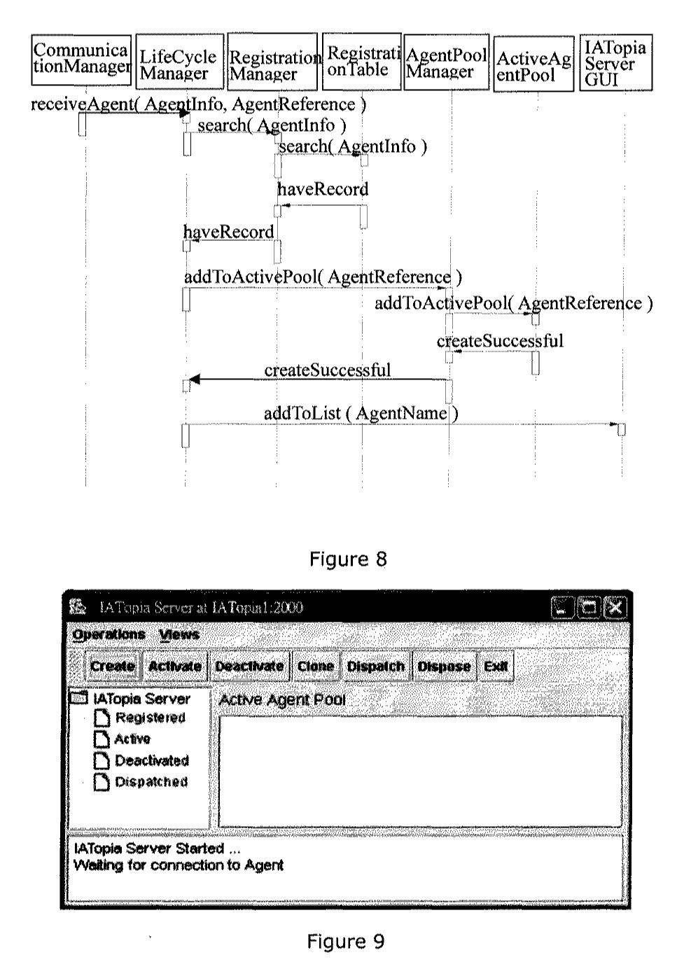

Dispatch Intelligent Agent: as shown in FIGS. 7 and 8, when the agent is created within the IATopia Server, user can use the IATopia Server GUI to select and dispatch agent. When the IATopia Server GUI receives the user's request, it will forward the request to the LifeCycleManager. LifeCycleManager will ask the RegistrationManager for the AgentCodeBase and then AgentPoolManager for the AgentReference.

And then send a dispatch request to the CommunicationManager to dispatch the agent object and class file if necessary. There is a server listener in to the remote machine. When the listener receives the dispatch request, it will forward the request to the LifeCycleManager. The LifeCycleManager will then check with the RegistrationManager that is that agent already registered in the remote server.

And then it will receive the agent object and then ask the AgentPoolManager to add the AgentReference into the ActiveAgentPool and update the IATopia Server GUI to notify the user that an agent has come to this server.

Programming IATo SDK: IATo SDK is developed with Java 1.4, since Java is an object oriented language. By using object oriented approach, program class or interface can be reused or further extend its function, so that the effect of outputting basic functionality may be saved. Java is a popular programming language; development of java program is cheaper and quicker then other programming languages. The portability of Java compiled code can easily be migrated to different kinds of system. Finally, the built-in network supporting programming mobile intelligent agent is another advantage.

User interface: As shown in FIG. 9, there are 4 regions on the user interface. The upper part contains a set of button including Create, Activate, Deactivate, Clone, Dispatch, Dispose and Exit. These buttons provide a user-friendly interface for the user to control the lifecycle of an agent. The lower part of the interface is the system log that will show the activities that have been taken place inside the server.

The middle part of the interface is divided into two areas. The left area displays the lists of agents that are in different status tree style, while the right hand side displays in a message broad style.

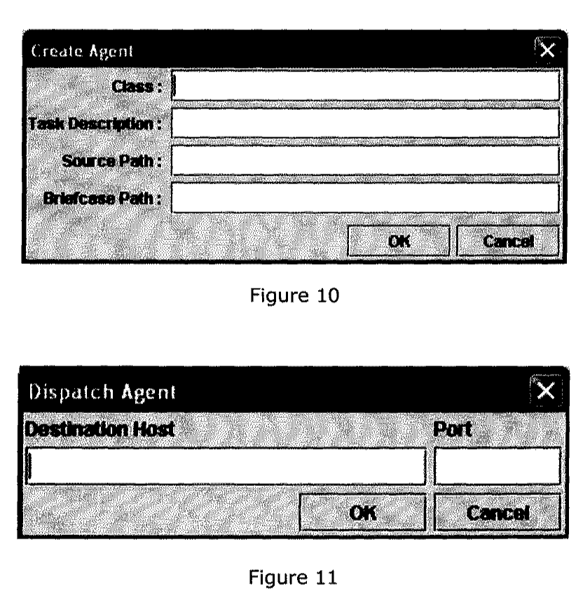

A mobile agent must be registered before starting its activities. This feature is also a security protection of the mobile agent system because it can prevent anonymous agent entering the system to car out expected damaging action. The registration of agent must be done by user by clicking the Create button. Then a “Create Agent Dialog” will pop up to ask for required information about the mobile agent (FIG. 10).

User must input a valid class name of the agent and the source path that is contains the class files inside the file system. Task description is an optional input, it is used to register the service in the RegistrationManager. Then the other agent can search for this agent by searching the registered service. After registering the agent with the task description and source path, user can activate the agent at any time to initiate its operation.

User can dispatch the mobile agent object to the other remote host at any time by clicking the Dispatch button. Then the “Dispatch Agent Dialog” will pop up to ask for information about where the mobile agent should be dispatched (FIG. 11). Users are required to input the destination host name/IP and the port number that the remote server is listening to.

Intelligent Agent Class: The Agent is the main character of the mobile agent concept. This is because it is a mobile software object that can transfer its software code and status from one host to another in order to perform a specific task. This can ensure the development of a Code on Demand system. The agent has its own mechanism to send messages to another agent for communication.

The Agent class is the basic class that the programmer can extend to create their own customized mobile agent. The API provides all functionalities that the agent can control its own lifecycle including the method for dispatching, deactivating, and disposing itself.

The dispatch method makes the agent hang the execution, save its status into a file and then send the status to the remote host. And to resume the execution code with the most updated status in the remote host. The deactivate method make the agent stop the execution. The dispose method will stop the agent thread's execution and also clear the status in the memory.

The Agent class also has a set of methods to get the attributes or the current status of the agent object. The getAgentName method can get the name of the agent inside the platform. The getAgentID method can get the ID assigned is to the agent. The getStatus method can check the agent in active or inactive state.

Now let's see how do we program our agent with the Agent class. We should import the IATopiaserver,*, in order to include all of the libraries that supporting us to write our agent. Then we can define our own agent by extending the Agent class.

import IATopiaserver.Agent;
public class HelloAgent extends Agent {
// implementation of the agent's method.
}

When an agent is created inside the agent platform, the platform must call the run method as default to start the execution of the agent thread. Therefore, we can write what is the default action that the agent must take by overriding the run method.

public void run( ) {
// default action of the action when created.
}

The agent can dispatch itself to the remote host by simply using the host name/IP and the port number that the remote server is listening to public void dispatch(String host_name, int port_num);

When the agent arrived the remote server, the IATopia Server of the remote host will call the arrived method on default to resume the execution of the agent thread. Therefore, we should tell the agent what to do in the remote host by overriding the arrived method.

```
public void arrived( ) {
    // what action need to take when resuming the execution on the
    remote host.
}
```

When one agent wants to talk to the other agent, it must get the reference of the other agent from the LifecyleManager by using getOtherAgent method with the agent's name.

public Agent getOtherAgent(String agent_name);

After getting the reference of the other agent, the agent can communication with each other. By using the sendMessge method, we can send an object which is in any object type ad containing any information to the other agent.

public void sendMessage(Object msg)

On the other hand, when the agent receive a message from the other agent. We can override the handMessage method to hand and give the appropriate response to the message.

public void handleMessage(Object msg) {
// what action need to take for the incoming message.
}

Sometimes we may need to get the reference of the LifeCycleManager in order to do some action, for example, creating the other agent. We can use the getLifeCycleManager method to get the reference of the LifeCycleManager.

public LifeCycleManager getLifeCycleManager( )

LifeCycleManager

LifeCyleManager act as the Agent Management System within the agent platform. It provides all functionalities of controls within the agent platform that include creating, suspending, resuming, dispatching and disposing agents.

After getting the reference of the LifeCycleManager, we can do some operations to control the lifecycle of the other agent inside the agent platform.

We can create a new instance or reactivate the agent object which is already be registered in the agent platform by using the agent class name.

public Agent activateAgent(String agentname, String activate)

By using the deactivateAgent method, the agent will stop its activity immediately and change the status to inactive.

public void deactivateAgent(String agentName)

The disposeAgent method will stop the activities of the agent immediately and remove the object from memory.

public void disposeAgent(String agentName)

When we need to talk to the agent by the client program, we can use the getOtherAgent of the LifeCycleManager to get the agent reference. So that we can send message to the agent and then inform the agent that what it may need to do.

public Agent getOtherAgent(String name)

Sometimes we may need to broadcast some message to all of the agent inside the agent platform. Therefore, we can call the getAllAgent to get an enumeration of agent reference to send message to every agent.

public Enumeration getAllAgent( )

RuntimeAgent: Sometimes we can write an application that is not necessary to be initiated by using the IATopia Server interface. Therefore, we can use a static class method from the RuntimeAgent class to create a new instance of the agent object by using the server name, listening port number and then agent class name as the parameter.

public static Agent createAgent(String server, int port, String agentname)

Various embodiments are provided below:

(1) HelloWorldAgent. This example shows the simplest way to create an agent which only display the Hello World Message on a awt frame.

```
import IATopiaserver.Agent;
import java.awt.*;
public class HelloWorldAgent extends Agent {
    transient Frame my_dialog; // transient means that this class will
    not be transfer during the disptach
      public void run( ) {
        message = “Hello World! I am ” + getAgentName( );
        my_dialog = new MyDialog(this);
            my_dialog.pack( );
            my_dialog.resize(my_dialog.preferredSize( ));
            my_dialog.show( );
    }
}
class MyDialog extends Frame {
    private HelloAgent agent = null;
    private Label msg = null;
    MyDialog(HelloAgent agent) {
        this.agent = agent;
        layoutComponents( );
    }
    private void layoutComponents( ) {
        msg = new Label(agent.message);
        Panel p = new Panel( );
        add(p);
        p.setLayout(new FlowLayout( ));
        add(msg);
    }
    public boolean handleEvent(Event ev) {
        if (ev.id == Event.WINDOW_DESTROY) {
            hide( );
            return true;
        }
        return super.handleEvent(ev);
    }
}
```

(2) HelloWorldAgent2. This example is the same structure as HelloWorldAgent but the agent will show the Hello World Message on a awt frame when it arrived the remote host.

```
public class HelloAgent2 extends Agent {
    transient Frame my_dialog;
    String message = null;
    public void run( ) {
        dispatch(“IATopia1”, 4444);
    }
    public void arrived( ) {
        message = “Hello World! I am ” + getAgentName( );
        my_dialog = new MyDialog(this);
            my_dialog.pack( );
            my_dialog.resize(my_dialog.preferredSize( ));
            my_dialog.show( );
    }
}
```

(3) In this example, an agent called TalkAgent will be created in 2 IATopia Server. The user need to click the connect button to make the connection between the two chatting agent in different host. Then the users can talk to each other by using the chatting interface. This examples shows that how can we create a new instance of the other agent (msgAgent) by using the getLifeCycleManager method. Also, this example also demonstrates how do the agent send and handle the message to do the communications.

```
import IATopiaserver.Agent;
public class TalkAgent extends Agent {
    transient Frame1 frame;
    String message = null;
    public void run( ) {
            frame = new Frame1(this);
            // codes to show the Frame1 interface
    }
    public void setDialog(Frame1 dlg) {
                this.frame = dlg;
    }
    public void handleMessage(Object msg) {
        if
(msg.toString( ).substring(0,msg.toString( ).indexOf(‘@’)).equals(“Connect”)) {
        frame.appendText(“Connected from ” +
            msg.toString( ).substring(msg.toString( ).indexOf(‘@’)  +  1,
    msg.toString( ).length( )));
        }
        else {
            frame.appendText(msg.toString( ).substring(msg.toString( ).indexOf(‘@’)
            + 1, msg.toString( ).length( )));
        }
    }
}
public class Frame1 extends JFrame {
    TalkAgent agent = null;
    msgAgent msgagent = null;
    String host = “”;
    int port = 0;
    String chat = “”;
    //Construct the frame
    void btn_Connect_actionPerformed(ActionEvent e) {
        try {
            InetAddress addr = InetAddress.getLocalHost( );
            host = destHost.getText( );
            port = Integer.parseInt(destPort.getText( ));
        msgagent  =
    (msgAgent)agent.getLifeCycleManager( ).activateAgent(“msgAgent”,
                    “ACTIVATE”);
            msgagent.setMsg(“Connect@” + addr.getHostName( ));
            msgagent.getLifeCycleManager( ).dispatchAgent(msgagent, host, port);
        }
        catch (UnknownHostException ex) {
        }
  }
  void jbtn_Send_actionPerformed(ActionEvent e) {
    msgagent =  (msgAgent)
agent.getLifeCycleManager( ).activateAgent(“msgAgent”,
                    “ACTIVATE”);
    msgagent.setMsg(“msg@” + msg.getText( ));
    msgagent.getLifeCycleManager( ).dispatchAgent(msgagent, host, port);
    msg.setText(“”);
    msg.updateUI( );
  }
  public void appendText(String_msg) {
    chat += _msg + “♯n”;
    text.setText(chat);
  }
}
import IATopiaserver.Agent;
public class msgAgent extends Agent {
  String msg = “”;
  public void arrived( ) {
    Agent agent = getOtherAgent(“TalkAgent”);
    agent.sendMessage(msg);
  }
  public void run( ) {
  }
  public void setMsg(String _msg) {
    msg = _msg;
  }
}
```

While implementing the present invention, base on the development platform of intelligent agent, the present invention is not limited in various embodiments described above. The present invention may expand to other application programs, as long as employing the intelligent agent based development platform to implement various application programs.

1. An intelligent agent based development platform, said platform provides intelligent agent based development environment, said development platform comprises:
First module, full artificial intelligence and ontology agent based application interface are provided to construct various intelligent agent application; and
Second module, for data storage, intelligent data analysis process, and providing analyzed results to said first module.

2. The development platform in claim 1, said first module comprises:
Application layer, comprises various intelligent ontology agent based application programs, said application programs are integrated by intelligent agent components of the intelligent layer and the data of said second module.
Ontology layer, base on the brain knowledge of agent, provides necessary knowledge for agent to initiate its logical and knowledgeable thinking.
Intelligent layer, provides artificial intelligence basic base on the sense field, logical illation field and analysis field, while utilizes agent components provided by technology layer.
Technology layer, provides necessary mobile agent object application program interface for intelligent agent components of intelligent layer, comprises providing IATo SDK software development tools of full multi-intelligent agent based development platform, and providing understandable marking language to increase the communication of intelligent agent and IATo ML development tools of data transferring; and
Supporting layer, provides all necessary systems for supporting said layer, comprises programming languages, communication protocols and standardized file exchange format that are adopted to facilitate the development of the IATopia framework.

3. The development platform in claim 1, said second module comprises:
Data layer, for storing raw data from intelligent agent brain. It is also the source of knowledge.
Neural network layer, for manipulating the data stored in the data layer so that knowledge can be generated and the thinking process can be initiated as well as the agent can learn or correct itself according to its experiences; and
Application layer, with the fully support from the data layer and neural network layer, agent have enough knowledge and thinking capability to live and work autonomously.

4. The development platform in claim 2, application programs in said application layer comprise:
IATo eMiner, an intelligent ontological web-mining agent system for e-shopping.
IATo InfoSeeker, an intelligent ontological knowledge based information searching system.
IATo WeatherMAN, an intelligent ontological weather forecasting agent.
IATo WShopper, an integrated ontological intelligent fuzzy shopping agent for intelligent mobile shopping on the Internet.
IATo Stock Advisor, an intelligent ontological agent based stock prediction system.
IATo Surveillant, the automatic ontological agent based surveillance system.

5. The development platform in claim 1, said intelligent agent comprises the following requirements: autonomous, mobile, reactive, proactive, adaptive, robust, communicative, learning, task-oriented, goal-driven.

6. The development platform in claim 2, said IATo SDK development tools comprise all the mandatory components arranged on intelligent agent development platform. Said mandatory components comprise intelligent agent managing system, information transferring server and index arbitrator.

7. The development platform in claim 1, the basic function and run time properties of said intelligent agent are defined by intelligent agent, lifecycle manager that provides all the control function, registration manager that records intelligent agent registration information in the intelligent agent development platform, and communication manager that controls the message transfer in intelligent agent platform.

8. The development platform in claim 1, said application program interface comprises: the first region that provides the functions of creating, activating, invalidating, copying, distributing, releasing and exiting, the second region that provides the functions of writing logs and displaying the information of activation in the server, the third region that provides tree type intelligent agent list, and the forth region that provides information broadcasting type.

9. The development platform in claim 2, said second module comprises:
Data layer, for storing raw data from intelligent agent brain. It is also the source of knowledge.
Neural network layer for manipulating the data stored in the data layer so that knowledge cm be generated and the thinking process can be initiated as well as the agent can learn or correct itself according to its experiences; and
Application layer, with the filly support from the data layer and neural network layer, agent have enough knowledge and thinking capability to live and work autonomously.
